(19) United States
(12) Patent Application Publication
(10) Pub. No.: US 2002/0190948 A1
(43) Pub. Date: Dec. 19, 2002

(54) Arcuate track joystick assembly

(76) Inventors: Alan R. Coutant, Peoria, IL (US); Robert J. Price, Dunlap, IL (US)

Correspondence Address: CATERPILLAR INC., 100 N.E. ADAMS STREET, PATENT DEPT., PEORIA, IL, 616296490

(21) Appl. No.: 09/883,027

(22) Filed: Jun. 15, 2001

(51) Int. Cl. G09G 5/08

(52) U.S. Cl. 345/161

(57) ABSTRACT

The present invention discloses a method and apparatus of an arcuate track joystick assembly. In an embodiment of the present invention, a joystick assembly is disclosed. The joystick assembly includes a joystick shaft having a longitudinal joystick axis, at least one guide member through which the joystick shaft extends, at least one follower mechanism connected with the joystick shaft and operative with the guide member, and a force member adapted to urge the follower mechanism into contact with the guide member.

### TECHNICAL FIELD

The present invention relates to a joystick for indicating a control signal, and, more particularly, to such a joystick which uses a combination of an arcuate track and a follower member to enable motion of the joystick shaft.

### BACKGROUND

In the construction industry, it is increasingly common to provide a work machine with a joystick-type mechanism to allow the operator to control the motion of the work machine or portions thereof. Additionally, these joystick mechanisms are well-known in many disparate fields for use in transmitting an operator's command(s) to a receiving unit, with computer and/or video game interfaces being chief among these applications.

There are several problems associated with the use of a joystick assembly as an interface, however. For example, in a work machine application, the joystick mechanism must be of robust construction as well as being of a size which allows it to be located conveniently for the operator. In any application, the internal components of the joystick tend to wear with sliding contact during use. This wear may produce a “sloppy” feel to the joystick for the operator. Also, it is efficient for an operator to control several work machine functions with one joystick interface.

An example of a joystick assembly is disclosed in U.S. Pat. No. 6,002,351, issued Dec. 14, 1999 to Genyo Takeda et al. (hereafter referenced as '351). '351 discloses a joystick device including a case and first and second rocking members respectively supported in an overlapped manner by first and second bearings formed in the case. First and second elongate holes defined through each of the first and second bearings are positioned perpendicular to each other. During operation, the lever is manipulated through the first and second elongate holes to cause tilt movement in at least one of the rocking members so that the movement of the rocking member is translated to a pulse signal for transmission to a detecting device. The '351 device offers only two degrees of freedom and is subject to the wear discussed above as the first and second rocking members slide relative to each other. The operation and interplay of the various components of the '351 joystick rely upon the holding of close tolerances therebetween. In addition, the mechanical linkage which allows for the movement-to-pulse-signal translation can be cumbersomely large and includes potentially fragile gears.

Accordingly, the art has sought a method and apparatus of a joystick assembly which: is of strong and robust construction; is resistant to wear caused by sliding contact between components; is of compact construction; offers two or more degrees of freedom of control movement; may be used in a timely and efficient manner; and is more economical to manufacture and use.

The present invention is directed to overcoming one or more of the problems as set forth above.

### SUMMARY OF THE INVENTION

In an embodiment of the present invention, a joystick assembly is disclosed. The joystick assembly includes a joystick shaft having a longitudinal joystick axis, at least one guide member through which the joystick shaft extends, at least one follower mechanism connected with the joystick shaft and operative with the guide member, and a force member adapted to urge the follower mechanism into contact with the guide member.

In an embodiment of the present invention, an apparatus for controlling a work machine is disclosed. The apparatus includes a joystick assembly having a joystick shaft movable to a plurality of positions, at least one follower mechanism attached to the joystick shaft, a guide member comprising at least one arcuate track, a force member urging the follower mechanism into contact with the arcuate track of the guide member, and at least one sensing member adapted to sense the position of the joystick shaft and responsively produce a position signal.

In an embodiment of the present invention, a method of providing a control signal for controlling various functions of a work machine is disclosed. The method includes the steps of providing a force to move the joystick shaft from a neutral position to a command position and thereby alter a physical condition of a follower member relative to an arcuate track, and reading the physical condition of the follower member and responsively producing a corresponding control signal.

### BRIEF DESCRIPTION OF THE DRAWINGS

FIG. 1 is an isometric view of a preferred embodiment of the present invention.

FIG. 2 is an isometric view of a preferred embodiment of the present invention, including a housing.

FIG. 3a is a front view of a preferred embodiment of the present invention positioned in a neutral orientation.

FIG. 3b is a side view, taken along line 3b-3b of FIG. 3a, of a preferred embodiment of the present invention positioned in a neutral orientation.

FIG. 4a is a front view of a preferred embodiment of the present invention positioned in a non-neutral orientation.

FIG. 4b is a side view, taken along line 4b-4b of FIG. 4a, of a preferred embodiment of the present invention positioned in a non-neutral orientation.

### DETAILED DESCRIPTION

A preferred embodiment of the present invention provides an apparatus and method for controlling a work machine. This invention may be applied to any type of work machine or to any suitable non-work machine interface application.

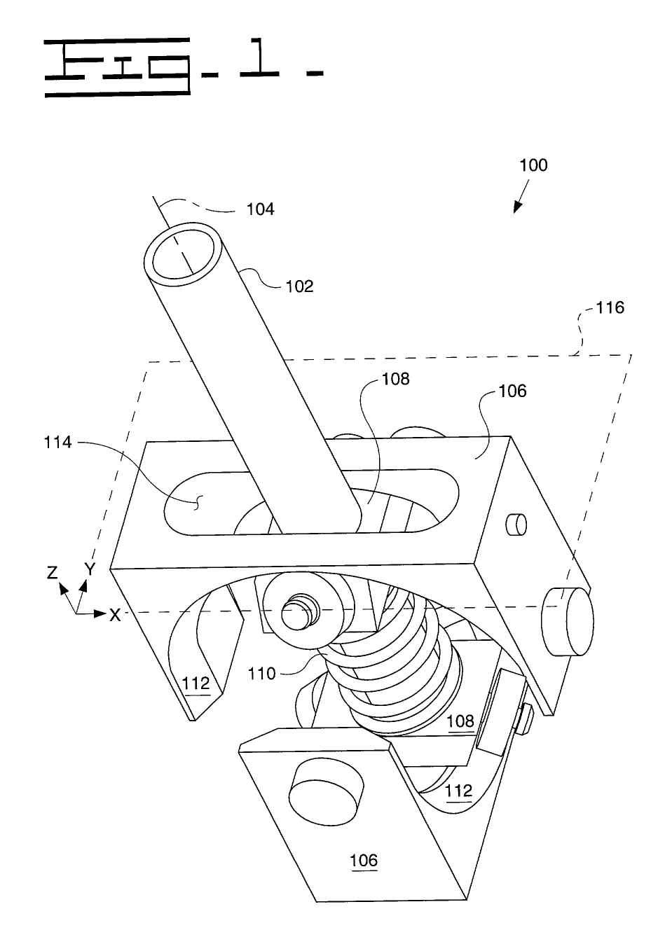

FIG. 1 shows a preferred embodiment of the present invention. A joystick assembly 100 is shown which includes a joystick shaft 102 having a longitudinal joystick axis 104, a guide member 106 through which the joystick shaft 102 extends, a follower mechanism 108 connected with the joystick shaft 102 and operative with the guide member 106, and a force member 110 adapted to urge the follower mechanism 108 into contact with the guide member 106. FIG. 1 shows a joystick assembly with two guide members 106 and two follower mechanisms 108, but the present invention can be made operational with any number of guide members 106 and follower mechanisms 108

Each guide member 106 includes an arcuate track 112 and an opening 114 through which the joystick shaft 102 extends and which allows the joystick shaft 102 to travel in a direction substantially lateral to the longitudinal joystick axis 104. By arcuate, what is meant is round, circular, elliptical, or any other suitable shape to allow continuous and preferably rolling contact between the follower mechanism 108 and the arcuate track 112. The guide members 106 are shown in the Figures as having concave arcuate tracks 112 oriented such that each curves around and partially encloses the force member 110. This orientation and style of arcuate track 112 in the Figures is shown for illustrative purposes only and is not meant to exclude the use of other orientations or styles of arcuate tracks 112, such as convex arcuate tracks 112 or an orientation of the arcuate tracks 112 away from the force member 110, in the present invention.

The force member 110 can be a piston, elastic band, clamp, or other suitable force-imposing device, but is discussed herein and shown in the Figures as a compression spring. The force member 110 acts to urge the follower mechanism 108 into contact with the arcuate track 112. Preferably, the contact between the follower mechanism 108 and the arcuate track 112 is firm enough to keep the follower mechanism 108 in continuous contact with the arcuate track 112 while still allowing the follower mechanism 108 to change position on the arcuate track 112.

Optionally, the arcuate track 112 may be shaped with a varying curvature (not shown) which provides a varying force feedback to the joystick shaft 102. This feedback could, for example, require a greater effort to move the joystick shaft 102 as it nears an end of the opening 114. Also, a suitable depression (not shown) in the arcuate track 112 could receive and hold the follower mechanism 108 to provide a desired detent function. This type of detent allows the operator of the work machine to place the joystick shaft 102 in a predetermined position, release the joystick shaft 102, and have the joystick shaft 102 stay in that predetermined position until such time as the operator chooses to move the position of the joystick shaft 102.

The joystick assembly 100 includes two orthogonal X and Y axes which define an X-Y plane 116. The guide member 106 includes at least one opening 114 which defines each of the X and Y axes. The joystick assembly 100 also includes at least one directional sensing member (not shown) such as, but not limited to, a magnetic position sensor, or any other type of sensor known in the art. This directional sensing member is adapted to sense the position of the joystick shaft 102 along each of the X and Y axes and responsively produce at least one signal which indicates the position of the joystick shaft 102 with respect to the X-Y plane 116 by producing an X-axis signal and a Y-axis signal. This feature allows an operator to provide fore/aft or back/forth motion, or any combination thereof, to the joystick shaft 102 with respect to the guide member 106 and thereby provide commands in two degrees of freedom in a traditional “joystick” manner.

The joystick shaft 102 optionally includes a variable Z-axis defined collinearly with the longitudinal joystick axis. In this additional embodiment, the joystick shaft 102 is adapted to move longitudinally along the variable Z-axis and a directional sensing member is adapted to sense the position of the joystick along the variable Z-axis and responsively produce a longitudinal Z-axis signal. The adaptation of the joystick shaft 102 to move longitudinally can be accomplished with any number of mechanisms known in the art; for example, the joystick shaft 102 may comprise an inner (fixed) sleeve which is attached to the follower mechanisms 108 and an outer (moving) partial sleeve which can be manipulated by the operator and which has a direction sensor member associated therewith. This feature allows an operator to raise or lower the joystick shaft 102 with a pull/push motion in respect to the guide member 106 and thereby provide commands in a third degree of freedom, which may be combined with any of the previous embodiments.

Optionally, the joystick shaft 102 is adapted to move rotationally around the variable Z-axis and a directional sensing member is adapted to sense the position of the joystick around the variable Z-axis and responsively produce a rotational Z-axis signal. The rotational movement could include a corresponding movement of one or more of the follower mechanisms 108. The adaptation of the joystick shaft 102 to move rotationally can be accomplished with any number of mechanisms known in the art; for example, the joystick shaft 102 may be rotationally supported within but not necessarily mounted to the follower mechanisms 108 and a slip ring or other commonly known sensor could sense the rotational movement of the joystick shaft 102. This additional embodiment allows an operator to rotate the joystick shaft 102 with a twisting motion in respect to the guide member 106 and thereby provide commands in a fourth degree of freedom, which may be combined with any of the previous embodiments.

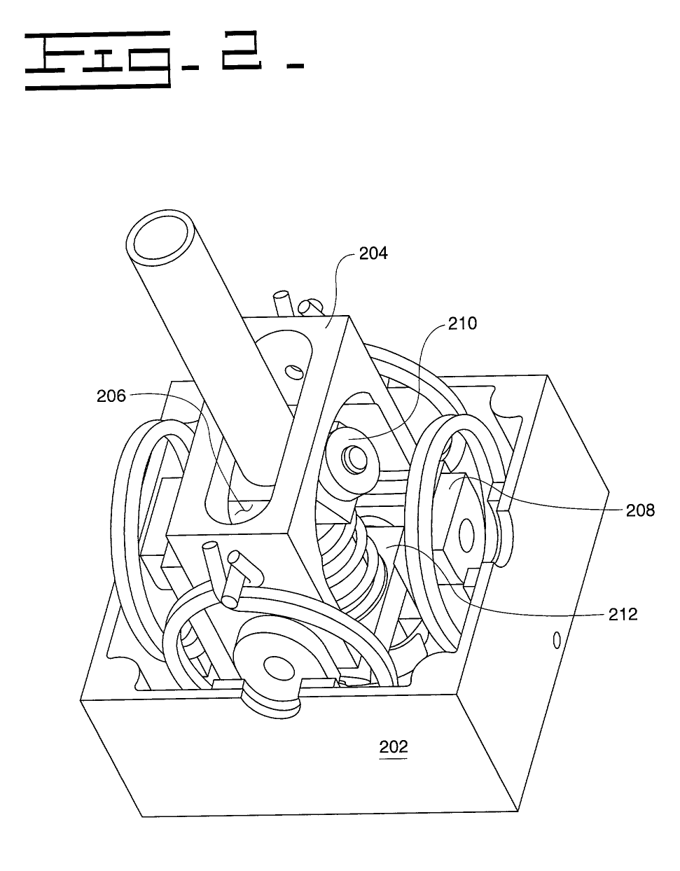

The joystick assembly 100 may include a housing 202, as shown in FIG. 2. This housing 202 acts to hold the guide member 106 in place with a first guide portion 204 with a slot 206 therethrough defining the X-axis and a second guide portion 208 with a slot (not shown) therethrough defining the Y-axis. The housing 202 holds the guide portions 204,208 with the slot 206 of the first guide portion 204 perpendicular to the slot of the second guide portion 208. The follower mechanism 108 in the embodiment shown in FIG. 2 includes a first follower portion 210 which is urged into contact with the arcuate track 112 of the first guide portion 204 by the force member 110 and a second follower portion 212 which is urged into contact with the arcuate track 112 of the second guide portion 208 by the force member 110. This embodiment also includes one or more centering mechanisms 214 which act to return the joystick shaft 102 to a neutral or centered position (such as the position shown in FIG. 2) from any location along the X, Y, or Z axes. Each centering mechanism 214 also provides a force feedback to the joystick shaft 102 when the joystick shaft 102 is moved by the operator. The centering mechanism 214 can be constructed to vary the force feedback, instead of or in addition to shaping the arcuate track 112 to provide a varying feedback.

While aspects of the present invention have been particularly shown and described with reference to the preferred embodiment above, it will be understood by those skilled in the art that various additional embodiments may be contemplated without departing from the spirit and scope of the invention. For example, the joystick shaft 102 may be of a nonlinear configuration, the guide member(s) 106 may be integrated with the housing 202, the follower mechanism 108 may be of a different configuration than that shown in the Figures, or the directional sensing member may be any one of a number of devices which provide a mechanical, electrical, and/or hydraulic signal indicating the position of the joystick shaft 102. However, a device or method incorporating such an embodiment should be understood to fall within the scope of the present invention as determined based upon the claims below and any equivalents thereof.

### INDUSTRIAL APPLICABILITY

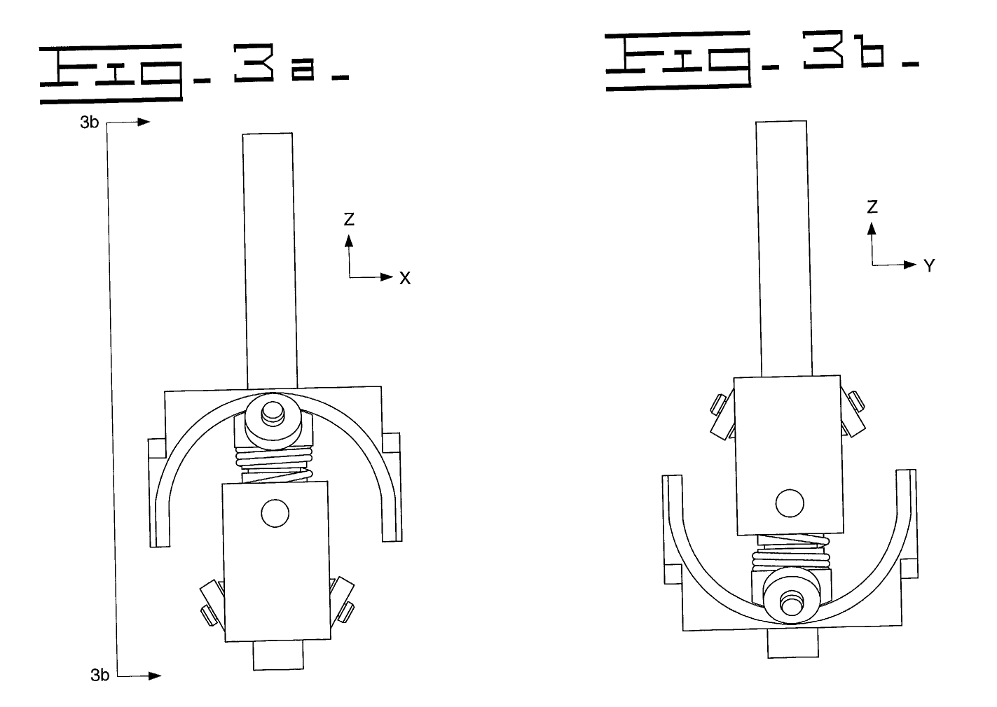

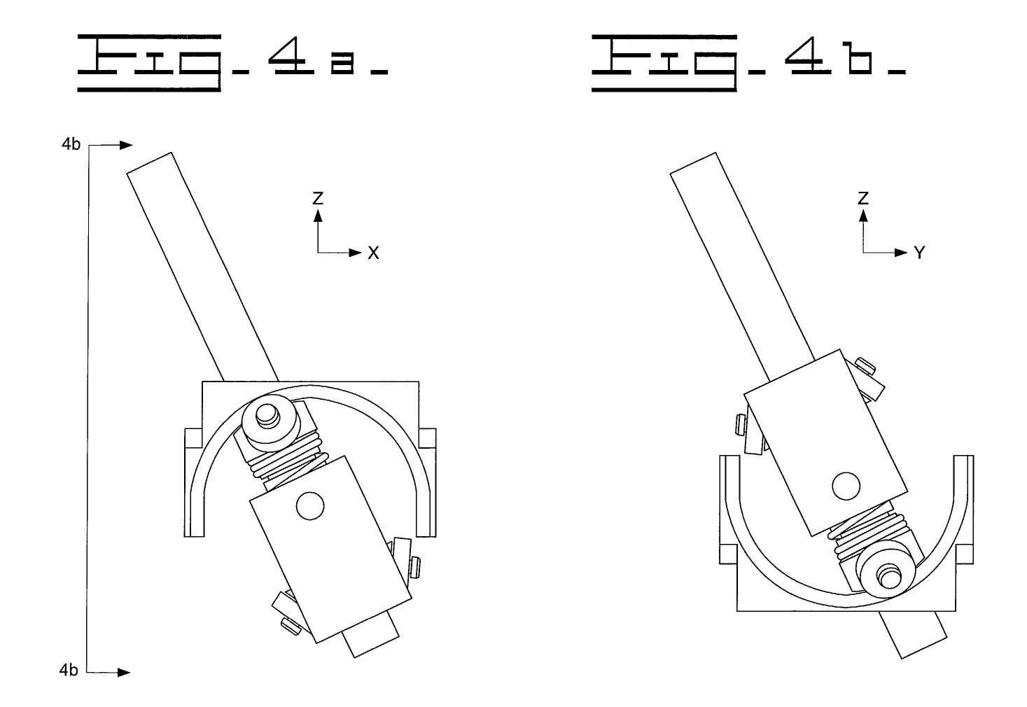

The operator of a work machine must transmit a desired command to the work machine. To do so, the operator grasps the joystick shaft 102 of the joystick assembly 100 of the present invention and provides a force to move the joystick shaft 102 from a neutral position (as shown in FIGS. 3a and 3b) to a command position (as shown in FIGS. 4a and 4b) corresponding to the desired command. By moving the joystick shaft 102, the follower mechanism 108 moves relative to the arcuate track 112. FIGS. 3a, 3b, 4a, and 4b clearly show the movement of the follower mechanisms 108 during use of the present invention with two possible degrees of freedom. The operation is substantially the same when a variable Z-axis function (such as longitudinal or rotational movement of the joystick shaft 102) is involved. The directional sensing member then reads the altered physical position or condition of the follower mechanism 108 and responsively produces a corresponding control signal. The control signal is then transmitted in a known manner to a controller on the work machine, which causes the work machine to carry out the operator's command.

As the operator moves the joystick shaft 102, the follower mechanism 108 is urged into contact against the arcuate track 112 by the force member 110. The arcuate track 112 can be shaped to provide varying force feedback to the operator and/or a detent function, both as detailed above. When the operator releases the force moving the joystick shaft 102, in the absence of a detent function, the joystick shaft 102 automatically returns to a neutral or centered position.

The apparatus and method of certain embodiments of the present invention, when compared with other methods and apparatus, may have the advantages of: being of strong and robust construction; being resistant to wear caused by sliding contact between components; being of compact construction; offering two or more degrees of freedom of control movement; being used in a timely and efficient manner; and being more economical to manufacture and use. Such advantages are particularly worthy of incorporating into the design, manufacture, and operation of joystick assemblies. In addition, the present invention may provide other advantages that have not been discovered yet.

Other aspects, objects, and advantages of the present invention can be obtained from a study of the drawings, the disclosure, and the appended claims.

What is claimed is:

1. A joystick assembly, comprising:
a joystick shaft having a longitudinal joystick axis;
at least one guide member through which the joystick shaft extends;
at least one follower mechanism connected with the joystick shaft and operative with the guide member; and
a force member adapted to urge the follower mechanism into contact with the guide member.

2. The joystick of claim 1, wherein the guide member comprises at least one arcuate track and an opening adapted to receive the joystick shaft while allowing the joystick shaft to travel in a direction lateral to the longitudinal joystick axis.

3. The joystick of claim 2, wherein the force member is adapted to urge the follower mechanism into contact with the arcuate track while allowing the follower mechanism to move relative to the arcuate track.

4. The joystick of claim 2, wherein the arcuate track has a varying curvature adapted to provide a predetermined physical feedback to the joystick shaft.

5. The joystick of claim 2, including two orthogonal X and Y axes for defining an X-Y plane, wherein the guide member includes an opening therethrough which defines each of the X and Y axes and a directional sensing member is adapted to sense the position of the joystick shaft along each of the X and Y axes and responsively produce an X-axis signal and a Y-axis signal.

6. The joystick of claim 5, including a variable Z-axis defined collinearly with the longitudinal joystick axis and wherein the joystick shaft is adapted to move longitudinally along the variable Z-axis and the directional sensing member is adapted to sense the position of the joystick along the variable Z-axis and responsively produce a longitudinal Z-axis signal.

7. The joystick of claim 6, wherein the joystick shaft is adapted to move rotationally around the variable Z-axis and the directional sensing member is adapted to sense the position of the joystick around the variable Z-axis and responsively produce a rotational Z-axis signal.

8. The joystick of claim 5, wherein the guide member includes a first guide portion with a slot therethrough defining the X-axis and a second guide portion with a slot therethrough defining the Y-axis and a housing for mounting the first and second guide portions with the slot of the first guide portion being perpendicular to the slot of the second guide portion, and wherein the follower mechanism includes a first follower portion which is urged into contact with the arcuate track of the first guide portion by the force member and a second follower portion which is urged into contact with the arcuate track of the second guide portion by the force member.

9. The joystick of claim 7, including a centering mechanism which urges the joystick shaft to a neutral central position from any location along the X, Y, or Z axes.

10. An apparatus for controlling a work machine, comprising:
a joystick assembly having a joystick shaft movable to a plurality of positions;
at least one follower mechanism attached to the joystick shaft;
a guide member comprising at least one arcuate track;
a force member urging the follower mechanism into contact with the arcuate track of the guide member; and
at least one sensing member adapted to sense the position of the joystick shaft and responsively produce a position signal.

11. The apparatus of claim 10, wherein the follower mechanism comprises a follower wheel which rolls along the arcuate track and the arcuate track is adapted to provide a detent function to the follower mechanism.

12. The apparatus of claim 10, wherein the arcuate track is contoured such that the force member asserts a predetermined varying force to urge the follower member into contact with the arcuate track of the guide member.

13. A method of providing a control signal for controlling various functions of a work machine, the work machine having a joystick assembly with a joystick shaft, comprising the steps of:
providing a force to move the joystick shaft from a neutral position to a command position and thereby alter a physical condition of a follower member relative to an arcuate track;
reading the physical condition of the follower member and responsively producing a corresponding control signal.

14. The method of claim 13, further comprising the steps of:
urging the follower member into contact against the arcuate track; and
varying a pressure of the contact between the follower member and the arcuate track dependent upon the position of the follower member relative to the arcuate track.

15. The method of claim 14, further comprising the step of:
automatically returning the joystick shaft to the neutral position upon removal of the force.
